(19) United States
(12) Patent Application Publication
(10) Pub. No.: US 2008/0262967 A1
(43) Pub. Date: Oct. 23, 2008

(54) Information processing method and device thereby

(75) Inventors: Yoichiro Sako, Tokyo (JP); Takashi Fukushima, Tokyo (JP); Jun Matsumoto, Kanagawa (JP); Shoji Yoshii, Tokyo (JP); Miki Abe, Kanagawa (JP); Tadao Akagi, Chiba (JP); Masamichi Asukai, Kanagawa (JP); Taiji Ito, Kanagawa (JP); Akane Sano, Tokyo (JP); Mitsuru Takehara, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/080,930

(22) Filed: Apr. 7, 2008

(30) Foreign Application Priority Data
Apr. 20, 2007 (JP) JP2007-111359

(51) Int. Cl. G06Q 40/00

(52) U.S. Cl. 705/44

(57) ABSTRACT

An information processing method, includes steps of detecting a use range set for one of digital money expressed in digital data and a use right of the digital money, and a use status of one of the digital money and the digital money right when one of the digital money and the digital money use right is used, determining whether the use status falls within the use range, and permitting the use of one of the digital money and the digital money use right if the use status falls within the use range or not permitting the use of one of the digital money and the digital money use right if the use status falls out of the use range.

### CROSS REFERENCES TO RELATED APPLICATIONS

The present invention contains subject matter related to Japanese Patent Application JP 2007-111359 filed in the Japanese Patent Office on Apr. 20, 2007, the entire contents of which are incorporated herein by reference.

### BACKGROUND OF THE INVENTION

1. Field of the Invention

The present invention relates to an information processing method and a terminal device for digital money and a use right of the digital money.

2. Description of the Related Art

In a digital money system based on an IC card, digital money is stored as electronic data on the IC card. A user presents the IC card to purchase an article or receive a service. The data on the IC card is then rewritten so that a corresponding sum is debited from the digital money. Digital money equal to a debit amount is transferred in payment to the article seller or the service provider. The digital money is thus used in the same way as currency.

The user receives digital money into the IC card from a bank account using a terminal such as a personal computer (PC) connected to the Internet. Conversely, the user can transfer unused digital money from the IC card to the bank account. The user can thus settle commercial transactions by exchanging data via the Internet.

A purpose of the digital money is recorded as digital data on the IC card. Also, a use right with an expiration limit set therewithin is also recorded on the IC card.

The digital money and the digital money use right, if stored on the IC card, are more difficult to forge than a magnetic stripe card.

Japanese Unexamined Patent Application Publication No. 2006-318453 discloses a technique in which data exchanged between an IC card and a reader/writer is encrypted to assure security.

Japanese Unexamined Patent Application Publication No. 2001-175748 discloses a system in which an expiration limit of digital money and a digital money use right is set. In the system, digital money and a digital money use right having an expiration limit set and digital money and a digital money use right having no expiration limit set are mixed.

### SUMMARY OF THE INVENTION

The digital money and the digital money use right are convenient and expected to be more widespread use. If an IC card storing digital money is held by a child, the child can buy goods not appropriate for him or her by the digital money.

Each user may wish to spend the digital money for a user's own particular purpose.

It is thus desirable to cause the use of the digital money and the digital money use right to match the user's own purpose.

In accordance with one embodiment of the present invention, an information processing method includes steps of detecting a use range set for one of digital money expressed in digital data and a use right of the digital money, and a use status of one of the digital money and the digital money right when one of the digital money and the digital money use right is used, determining whether the use status falls within the use range and permitting the use of one of the digital money and the digital money use right if the use status falls within the use range or not permitting the use of one of the digital money and the digital money use right if the use status falls out of the use range.

In accordance with the information processing method, the user may not be permitted to use the digital money and the digital money use right if use conditions under which one of the digital money and the digital money use right is used falls outside a use range set for one of the digital money and the digital money use right. The use conditions include a purpose of use, a date and time and an area of the use of the digital money and the digital money use right.

The above arrangement provides a parent lock function so that a child is not permitted to use the digital money and the digital money use right, such as to purchase an article inappropriate for the child. The digital money and the digital money use right are thus used in a mode satisfying each individual user.

### BRIEF DESCRIPTION OF THE DRAWINGS

FIG. 1 is one example of digital money medium;

FIG. 2 illustrates a first example of a set use range of the digital money in accordance with one embodiment of the present invention;

FIG. 3 illustrates a second example of the set use range of the digital money in accordance with one embodiment of the present invention;

FIG. 5 illustrates a system that sets the use range of the digital money in accordance with one embodiment of the present invention;

FIG. 6 illustrates a system that uses the digital money in accordance with one embodiment of the present invention; and

FIG. 7 illustrates a limitation process limiting the use of the digital money.

### DESCRIPTION OF THE PREFERRED EMBODIMENTS

The digital money indicates an amount of money or point by encrypted electronic data. The amount of money may be represented in any currency, such as yen or dollars. The point may be any thing that can be redeemed for commercial products or service.

The digital money medium is a recording medium such as an IC card that contains the digital money in the form of electronic money data. The digital money medium is a so-called electronic wallet.

Depending on communication method, the digital money media may divided into a contact type, a contactless type, and a combination type working as the contact type and the contactless type. The contact type digital money medium, having a terminal to be mated with a reader/writer, is powered from and communicates with the reader/writer. The contactless type, having an antenna, is placed in proximity to a reader/writer to be powered from and communicate with the reader/writer. The combination type has the functions of the above two types. The digital money medium may be any of the three types.

Depending on structure, the IC cards may be divided into three types. A first type includes a memory and a central processing unit (CPU). A second type includes a memory and a logic circuit performing simple control. A third type includes only memory without CPU. Any of the three types is perfectly acceptable.

Digital money systems are divided into two types. A first type is a prepaid type in which an amount of money is charged on the digital money medium. A second type is a combination of a prepaid method and a payment-on-credit method. Either system is perfectly acceptable.

A mobile terminal, such as a cell phone containing an IC card or a digital money medium, is also a digital money medium.

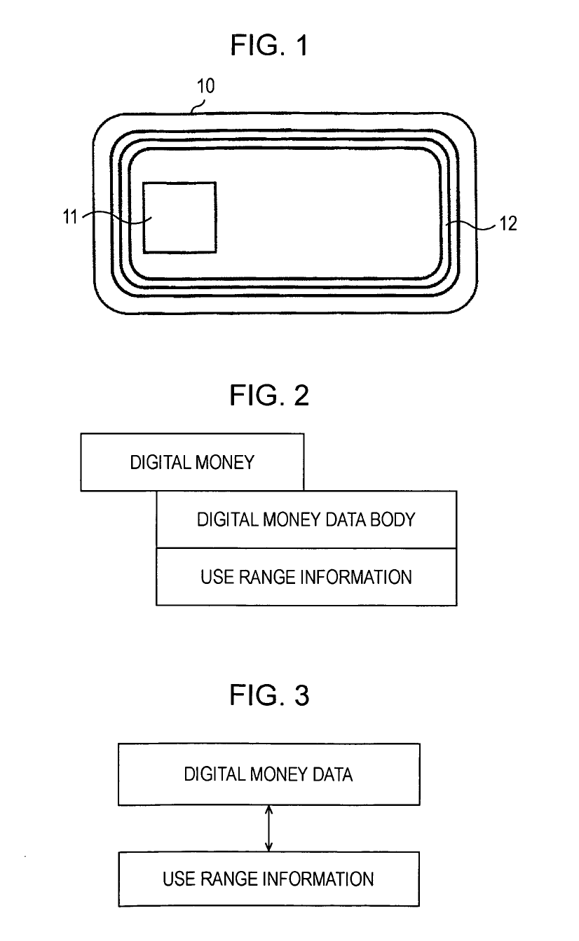

FIG. 1 illustrates a digital money card 10 as one example of the digital money medium. The digital money card 10 is a contactless IC card such as FeliCa (Registered Trademark). The digital money card 10 includes an IC chip 11 and an antenna 12. Digital money data is stored on a memory in the IC chip 11.

In accordance with one embodiment of the present invention, a use range is set on the digital money in a method described below.

As shown in FIG. 2, the use range is set on the digital money, i.e., the digital money data. More specifically, the digital money data to be stored on the memory in the IC chip 11 of the digital money card 10 contains the digital money data body and use range information attached thereto.

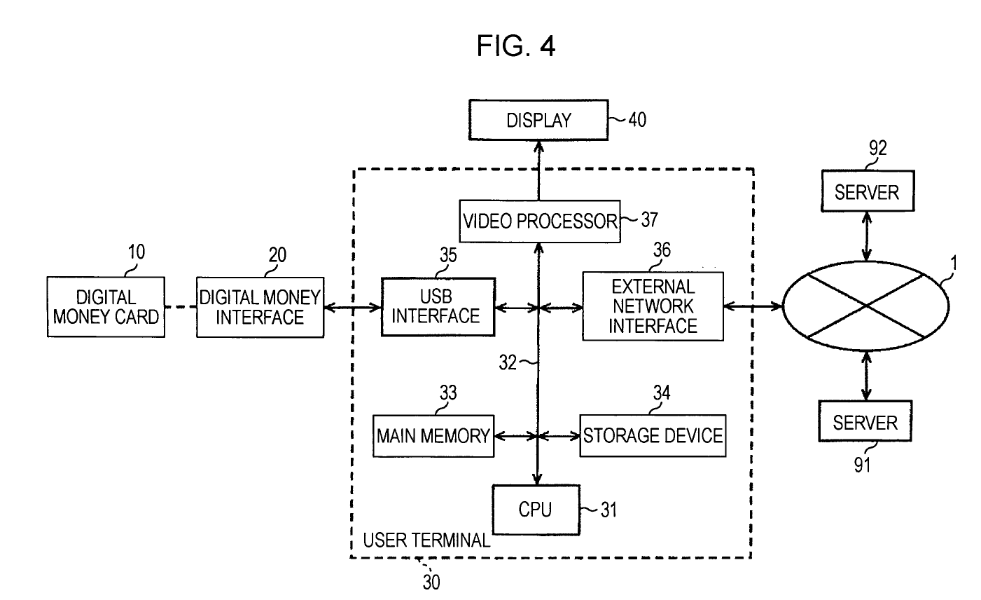

As shown in FIG. 3, the use range is set on the digital money medium. More specifically, the digital money data and the use range information are recorded on the memory in the IC chip 11 of the digital money card 10.

In each case, the use range information indicates the use range of the digital money, i.e., limits the usable range of the digital money.

The use range of the digital money refers to a purpose, a date and time, and an area of the use of the digital money.

The purpose of the use of the digital money indicates an article the user can purchase for the digital money or a service the user can receive for the digital money. The date and time of the use of the digital money refer to the day of the week or time band within which the user can use the digital money. The area of the use of the digital money refers to a place where the user can use the digital money. For example, the area of the use of the digital money is a location of a store or a facility.

The use range information identifies at least one of the purpose, the date and time, and the area.

For example, the use of the digital money may be limited as follows: (a) the digital money cannot be used to purchase liquor and tobacco, (b) the digital money cannot be spent for a gambling activity, (c) the digital money cannot be used in a time band of from 10 p.m. to 5 a.m., and (d) the digital money cannot be used in a specified area.

Furthermore, the use of the digital money may be limited as follows: (e) the digital money can be used to purchase stationary products, sporting goods and food, (f) the digital money can be spent for an amount of $30.00 per purchase, (g) the digital money can be used within a time band of from 5 a.m. to 10 p.m., and (h) the digital money can be used within a specified area only.

As shown in FIG. 2, the use range information is attached to the digital money data. Each time an amount of money is deposited to or withdrawn from the digital money card 10, the use range information is set on the digital money.

As shown in FIG. 3, the use range information is recorded as different information onto the digital money data. When the digital money card 10 is issued or subsequent to the issuance of the digital money, the use range information is recorded on the digital money card 10. The use range information is set on the entire digital money stored in the digital money card 10.

In each case, the use range information is encrypted in the same manner as the digital money data body and the digital money data. The use range information is also accompanied by one of an error detection code and an error correction code.

FIG. 4 illustrates a system that sets the use range on the digital money.

The system is a user terminal 30 such as a personal computer. The user terminal 30, connected to one of a server 91 operating a digital money system on the Internet 1 and a server 92 of a banking institution, sets the use range to the digital money.

The user terminal 30 includes a CPU 31, a main memory 33, a storage device 34, and a bus 32 connected to each of those elements. Each of programs and a variety of data is expanded onto the main memory 33. The storage device 34 includes a semiconductor memory or a hard disk. The storage device 34 stores a variety of programs and data.

The bus 32 connects to a universal serial bus (USB) interface 35, an external network interface 36 and a video processor 37. The USB interface 35 connects to a digital money interface 20. The external network interface 36 connects to the Internet 1. The digital money interface 20 arranged outside the user terminal 30, such as PaSoRi (Registered Trademark) is connected to the USB interface 35. A display 40 is connected to the video processor 37.

Data to be exchanged between the user terminal 30 and each of the servers 91 and 92 is encrypted to assure security of the system.

To set the use range (or non-use range) onto the digital money card 10 as shown in FIG. 3, the user connects the user terminal 30 to the server 91 operating the digital money system. The user calls a setting screen on the display 40 and swipes the digital money card 10 over the digital money interface 20 connected to the user terminal 30.

A column ready to receive the use range input by the user in text is arranged on the setting screen. The use ranges (a) through (h) prepared beforehand as listed above are displayed in a pattern code such as a quick response (QR) code, a point of sales (POS) code, or a radio frequency identification (RFID) code.

The user inputs the use range into a text input column and selects a pattern code representing a use range to be set, from among a plurality of pattern codes.

The server 91 transmits to the user terminal 30 information indicating the use range information input or selected as the use range information. The user terminal 30 stores the use range information on the digital money card 10, thereby setting the use range on the digital money card 10.

When digital money is received from an bank account and deposited onto the digital money card 10, the user can set the use range onto the deposited digital money.

In this case, the user connects the user terminal 30 to the server 92 of the banking institution and calls on the display 40 a screen for depositing money (if viewed from the banking institution, the money being withdrawn). The user then swipes the digital money card 10 over the digital money interface 20 connected to the user terminal 30.

A column for receiving data input about an amount of money is arranged on a deposit and setting screen. As in the above-described setting screen, a column for receiving the use range in text from the user is also arranged on the deposit and setting screen. The model use ranges such as the use ranges (a) through (h) are displayed in a pattern code such as the QR code.

The user inputs the use range in a text input column and selects a pattern code indicating the use range to be set from among the codes.

The server 92 attaches to the digital money data body the use range information indicating the use range input or selected and then transmits the digital money data to the user terminal 30. The user terminal 30 stores the digital money data on the digital money card 10, thereby setting the use range onto the digital money.

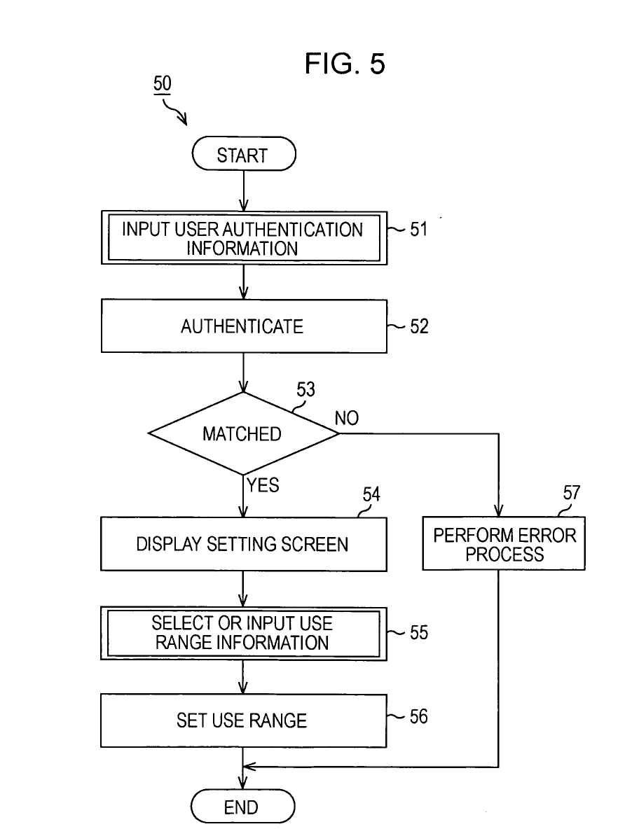

FIG. 5 illustrates a use range setting process 50 performed by the system including the user terminal 30 and the servers 91 and 92. Steps S51 and S55 may be performed by the user.

In step S51 in the use range setting process 50, the user inputs user authentication information with the user terminal 30 connected to one of the servers 91 and 92.

The user authentication information is finger vein, fingerprint, a password or the like. The user authentication information is pre-registered and the user is authenticated according to the user authentication information.

When the user has entered the user authentication information, the system matches the entered user authentication information against the registered user authentication information. In step S53, the system determines whether the two pieces of user authentication information match each other.

If it is determined in step S53 that the entered user authentication information matches the registered user authentication information, processing proceeds from step S53 to S54. The above-described setting screen is displayed.

When the setting screen appears, the user selects or enters the use range in step S55.

When the user has selected or entered the user authentication information, the system sets the use range in step S56.

If it is determined in step S53 that the entered user authentication information does not match the registered user authentication information, processing proceeds from step S53 to S57. The system then performs an error process, for example, displaying an indication that user authentication has failed.

The user terminal 30 for setting the use range may have the function of connecting to the Internet and may be one of a mobile terminal or a wireless terminal, such as a cell phone containing a digital money medium.

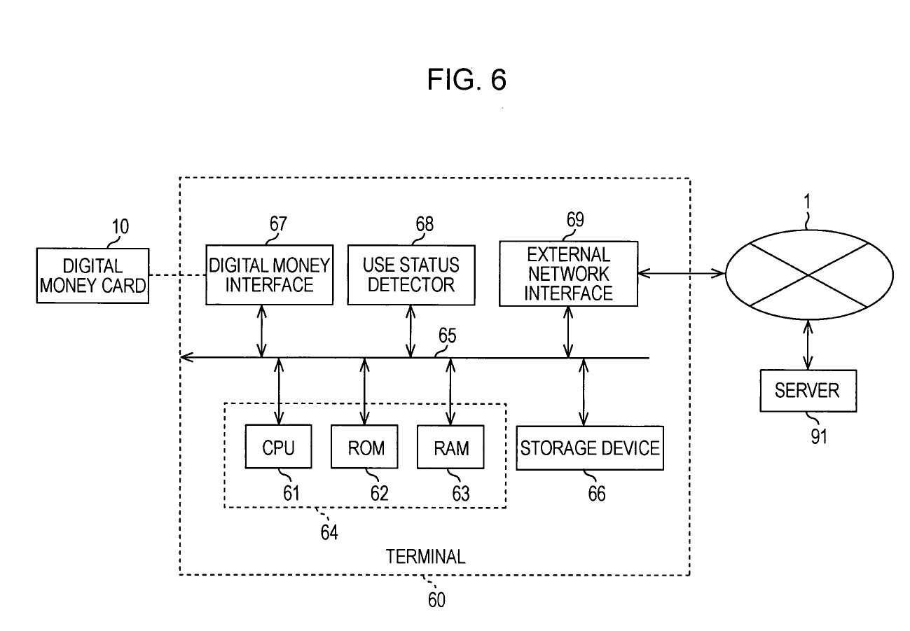

FIG. 6 illustrates a system that uses the digital money.

In the system, a terminal 60 is connected via the Internet to the server 91 operating a digital money system.

The terminal 60 may be installed in a store selling commodities or a place providing service. The terminal 60 presents a digital money card 10 to pay for an article or service. The terminal 60 has the function of a reader/writer and a function of detecting use status of the digital money.

More specifically, the terminal 60 includes a controller 64, a storage device 66, a digital memory interface 67 such as FeliCa (Registered Trademark), a use status detector 68, an external network interface 69 for connecting the user terminal 30 to the Internet 1 and a bus 65 interconnecting these elements. The controller 64 includes a CPU 61, a ROM 62 and a RAM 63.

The use status detector 68 detects the status in which the digital money card 10 is displayed on the terminal 60 and the digital money on the digital money card 10 is used. More specifically, the use status detector 68 detects the purpose, the date and time and the area of the use of the digital money.

When a barcode reader or the like in a register serving as the terminal 60 or connected to the terminal 60 receives a type or name of an article to be purchased by the user or a type or name of a service to be provided to the user in a store or a facility, the purpose is detected.

The date and time are detected by a calendar circuit or a time measuring circuit contained in the terminal 60.

The store or facility having the terminal 60 installed therewithin is registered beforehand on the ROM 62 or the storage device 66 in the terminal 60. The area is thus detected. The area may also be detected using a global positioning system (GPS) or wireless fidelity (WiFi).

To use the digital money to purchase article or service, the user swipes the digital money card 10 over the digital memory interface 67 on the terminal 60.

The controller 64 in the terminal 60 determines whether the use status detected by the use status detector 68 falls within the set use range. The use range is set on one of the digital money in the digital money card 10 or on the digital money card 10.

If the use status falls within the use range, the controller 64 performs a process to permit the user to use the digital money. More specifically, the controller 64 performs a process to permit the user to purchase an article or service for the digital money in the digital money card 10. If the use status falls outside the user range, the controller 64 performs a process not to permit the user to use the digital money. For example, the controller 64 notifies the user that the user is not permitted to use the digital money because of a limitation on the use of the digital money. A display or a buzzer on the terminal 60 is activated to so notify the user.

If a parent sets one of the use ranges (a)-(d) and (e)-(h) on the digital money card 10 held by his or her child, the child can use the digital money card 10 within the set use range. The so-called parent lock is thus set.

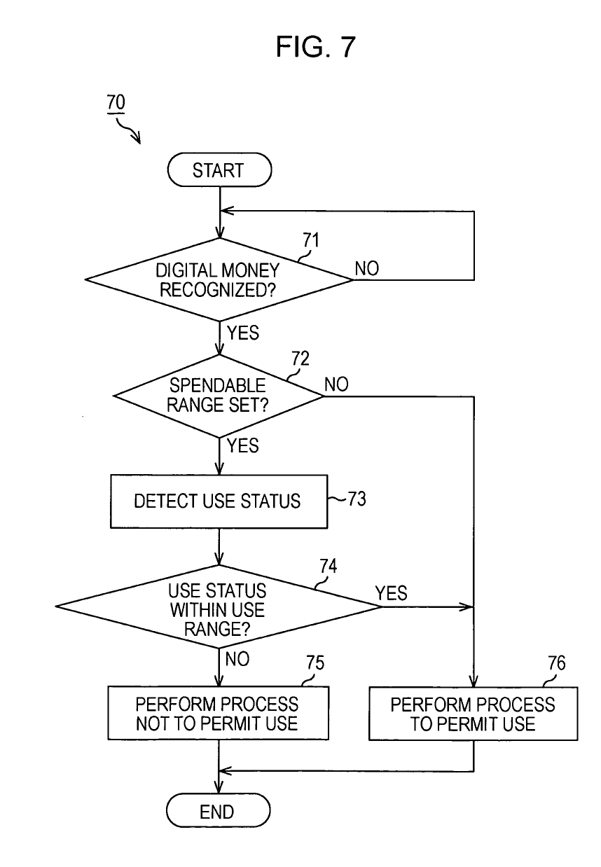

FIG. 7 illustrates a digital money use limitation process 70 of the controller 64 in the terminal 60 performed when the digital money is used.

In step S71 in the digital money use limitation process 70, the controller 64 determines whether the digital money card 10 is recognized. When the digital money card 10 is swiped over the digital memory interface 67 in the terminal 60, the controller 64 recognizes the digital money card 10. Processing proceeds to step S72. Depending on whether the use range information is recorded on the digital money card 10, the controller 64 determines whether the use range is set.

If the use range is set, processing proceeds from step S72 to step S73. The use status detector 68 detects the use status of the digital money. In step S74, the use status detector 68 determines whether the use status falls within the use range.

If the use status falls outside the use range, processing proceeds to step S74 to S75. The controller 64 performs the process not to permit the user to use the digital money. If the use status falls within the use range, processing proceeds from step S74 to step S76. The controller 64 performs the process to permit the user to use the digital money.

If the use range is not set, processing proceeds from step S72 to step S76. The controller 64 performs the process to permit the user to use the digital money.

The terminal may be not the one installed in a store or facility but a user terminal such as a personal computer or a cell phone. The user then purchases an article or service. In such a case, the above-described method works.

When the status of the user has changed, for example, when a minor reaches age of majority or when life of the user has changed, the limitation to the use of the digital money is removed or the use range (non-use range) of the digital money is modified.

The setting of the use range is thus canceled or modified.

The system of FIG. 4 and the method of FIG. 5 may be used for cancellation or modification of the use range of the digital money.

The above discussion is related to the digital money. The present invention is equally applicable to the digital money use right.

The use right may be the one for mileage, coupon, and content playing. The use right is encrypted electrical data. As in the digital money, the use range, i.e., at least one of the purpose, the date and time, and the area is set on the use right.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing method, comprising steps of:
detecting a use range set for one of digital money expressed in digital data and a digital money use right, and a use status of one of the digital money use and the digital money right when one of the digital money and the digital money use right is used;
determining whether the use status falls within the use range; and
permitting the use of one of the digital money and the digital money use right if the use status falls within the use range or not permitting the use of one of the digital money and the digital money use right if the use status falls out of the use range.

2. The information processing method according to claim 1, wherein the use range is set as part of information indicating one of the digital money and the digital money use right.

3. The information processing method according to claim 1, wherein the use range is set as information to be stored on a recording medium storing one of the digital money and the digital money use right.

4. The information processing method according to claim 1, wherein the use range indicates a range within which the use of one of the digital money and the digital money use right is permissible, and wherein the use status indicates a result of the use of one of the digital money and the digital money use right.

5. The information processing method according to claim 1, wherein the use range indicates a date and time range within which the use of one of the digital money and the digital money use right is permissible, and wherein the use status indicates a date and time at which one of the digital money and the digital money use right has been used.

6. The information processing method according to claim 1, wherein the use range indicates a geographical area within which the use of one of the digital money and the digital money use right is permissible, and wherein the use status indicates a geographical area where one of the digital money and the digital money use right has been used.

7. The information processing method according to claim 1, wherein information indicating the use range is retrieved over a network.

8. The information processing method according to claim 1, wherein the use range is set by a user of one of the digital money and the digital money use right.

9. A terminal device, comprising:
interface means for indicating a recording medium storing one of digital money expressed in digital data and a digital money use right;
detecting means for detecting a use range set for one of the digital money and the digital money use right, and a use status of one of the digital money and the digital money use right when the recording medium is indicated on the interface means; and
information processing means for permitting the use of one of the digital money and the digital money use right if the use status falls within the use range or not permitting the use of one of the digital money and the digital money use right if the use status falls out of the use range.

10. The terminal device according to claim 9, wherein the use range is set as part of information indicating one of the digital money and the digital money use right.

11. The information processing method according to claim 9, wherein the use range is set as information to be stored on the recording medium storing one of the digital money and the digital money use right.

12. A recording device for setting, on a recording medium, information indicating a use range limiting a use of one of digital money and a use right of the digital money recorded on the recording medium.

13. A computer readable recording medium storing data indicating one of digital money and a use right of the digital money and information regarding a usage range limiting a use of one of the digital money and the use right of the digital money.

14. A terminal device, comprising:
an interface unit indicating a recording medium storing one of digital money expressed in digital data and a digital money use right;
a detecting unit detecting a use range set for one of the digital money and the digital money use right, and a use status of one of the digital money and the digital money use right when the recording medium is indicated on the interface unit; and
an information processing unit permitting the use of one of the digital money and the digital money use right if the use status falls within the use range or not permitting the use of one of the digital money and the digital money use right if the use status falls out of the use range.
